(19) United States
(12) Patent Application Publication
(10) Pub. No.: US 2006/0274338 A1
(43) Pub. Date: Dec. 7, 2006

(54) Method and system for inter-channel clock frequency selection with periodic halftoning

(75) Inventors: Kenneth R. Crounse, Somerville, MA (US); Vladimir Levantovsky, North Andover, MA (US)

Correspondence Address: BREINER & BREINER, L.L.C., P.O. BOX 19290, ALEXANDRIA, VA, 22320-0290, US

(73) Assignee: MONOTYPE IMAGING, INC., Woburn, MA (US)

(21) Appl. No.: 11/146,195

(22) Filed: Jun. 7, 2005

(51) Int. Cl. G06F 15/00

(52) U.S. Cl. 358/1.9; 358/3.01

(57) ABSTRACT

At least two different pixel clock frequencies or pixel pitches are used when generating an image. They are used with periodic halftone patterns in a color scanning printing process. By using different clock frequencies for the different color separations, more options for screen geometry are available, and therefore new screen sets with desirable moiré behavior are possible. This is especially important on low resolution devices, such as 1200 dpi and below. Here there are a limited number of rational tangent screen geometries that are available and moiré canceling or moiré averting combinations are scarce. The different pixel clock frequency are used when writing at least two color channels in order to provide otherwise unavailable halftone geometries.

### FIELD OF THE INVENTION

At least two different pixel clock frequencies or pixel pitches are used when generating an image. They are used with periodic halftone patterns in a color scanning printing process. By using different clock frequencies for the different color separations, more options for screen geometry are available, and therefore new screen sets with desirable moiré behavior are possible.

### BACKGROUND OF THE INVENTION

Images are typically recorded and stored as contone images in which each image element or pixel has a color tone value. For example, consider a digitally stored “black and white” image—each image element will have a corresponding value setting its tone, among 256 gradations, for example, between white and black. Color images may have three or more tone values for each of the primary colors.

Many printing processes, however, cannot render an arbitrary color tone value at each addressable location or pixel. Most flexographic, xerographic, inkjet, offset printing, electrophotographic (including, for example laser printers, light emitting diode (LED) printers, multifunction devices that include print capabilities, and digital copiers) processes are basically binary procedures in which color or no color is printed at each pixel. At each addressable point on a piece of paper, these processes can generally either lay down one or more dots of colorant or colorants, or leave the spot blank.

For example, in most electrophotography-based devices, toner is selectively transferred to a drum that has been electrostatically charged in the pattern of the desired image by illumination from a bar of light emitting diodes. The toner is then transferred from the drum to the print media and then fused there. In some color devices, a series of drums are provided for each of the different image separations or color planes. For example in a common four-color printing process, the cyan, magenta, yellow, and black toners are added by successive drums to build the color spectrum on the paper media. In other arrangements, the color spectrum is built on a single drum and then transferred to the media.

In inkjet printing systems, the image is loaded into a print driver that drives the inkjet print head. This head then deposits ink droplets of various colors such as cyan, magenta, yellow, and black in order to render the image in a lateral or x axis on the typically paper substrate media. The paper (or in some cases the head) is translated to address longitudinal, feed, or y axis. Sometimes, however, the head is provided with columns of nozzles that partially address the y axis.

Offset printing is used in many commercial applications. The print media travels through multiple printing press units. Each unit sequentially applies different image separations or color planes to the paper web. For example, in a common four-color printing process, the cyan, magenta, yellow, and black inks are added by successive printing press units to build the color spectrum on the web.

The image is held on these press units typically on a printing plate. Separate printing plates are provided for each of the separations in each of the press units. Newer computer to plate systems enable the generation of the image directly on these plates. In other systems, however, the image is first formed on a film substrate and then transferred to the printing plate.

Converting a contone image to a format compatible with these printing process restrictions is termed halftoning. Color tone values of the contone image elements become binary dot patterns that, when averaged, appear to the observer as the desired color tone value. The greater the coverage provided by the dot pattern, the darker the color tone value.

A number of techniques exist for determining how to arrange the halftone dots in the process of transforming the contone image into the halftone image. A common approach to creating digital halftones uses threshold masks or screens to simulate the classical optical approach. These masks are arrays of thresholds that spatially correspond to the addressable points or pixels on the output medium. At each location, an input value from the contone image is compared to a threshold to make the decision whether to print a dot or not.

In the simplest case, classical screens produce halftone dots that are arranged along parallel lines in two directions, i.e., at the vertices of a parallelogram tiling in the plane of the image. If the two directions are orthogonal, the screen can be specified by a single angle and frequency.

However, it is a well known problem of periodic screening that, due to unwanted common absorption spectral bands among the inks, moiré interactions can appear on the printed output. To avoid moiré, exact angle and frequency combinations can be used to “cancel” the interaction. One such combination is to use the classical angles (75, 15, 45 degrees) for three of the channels, all at the same frequency. An infinite number of moiré canceling combinations exist, however. Furthermore, it is also possible to design screens such that the moiré is too high a frequency to be noticeable (e.g., a rosette pattern).

On a digital printing system, the possible angles and frequencies of the periodic pattern are restricted by the discrete nature of the underlying pixel grid. Unfortunately, the classical angles and frequencies cannot be exactly reproduced, because of their irrational tangents.

Some methods, such as Agfa Balanced Screening, see U.S. Pat. No. 5,155,599, can overcome this problem by making small changes to the desired angle and frequency by an appropriate rational approximation while still preserving moiré cancellation properties. But, at low resolutions, other artifacts of the approximation are visible, in particular the “auto-moiré” phenomena, which is a type of digital aliasing. On the other hand, non-classical moiré canceling/averting combinations are possible on the digital grid, but these are very scarce at low resolutions.

The pixel grid of a typical electrophotographic printing device is established by two parameters: the clock frequency of the signal sent to the scanning laser of the laser printer, imagesetter, or platesetter, (or ink drop depositor in the case of an inkjet printer) in scan (or X-axis) direction, and the stepper motor/drum/feed mechanism rate in paper feed (or Y-axis) direction. Parameters are typically set to achieve a standard resolution, such as 600 dots per inch (dpi), in both directions.

Improvements in lasers and electronic bandwidths have allowed the use of higher scanning frequencies providing higher resolutions in the X direction (e.g., 2400 dpi), which can provide prints with reduced graininess, increased detail, and reduced moiré via improved halftone geometry. However, such systems require the use of higher quality toners and inks and more expensive components, and may be slower due to the increase in data in the imaging pipeline.

### SUMMARY OF THE INVENTION

The present invention relates to the use of at least two different pixel clock frequencies or pixel pitches. They are used with periodic halftone patterns in a color printing process. By using different clock frequencies for the different color separations, more options for the physical screen geometry are available, and therefore new screen sets with physical geometries/pixel sizes can be created to yield desirable moiré behavior. This is especially important on low resolution devices, such as at 1200 dpi and below. Here a limited number of rational tangent screen geometries are available and moiré canceling or moiré averting combinations are scarce when using conventional screen sets that have the same pixel pitch across each of the screens in the set.

The different pixel clock frequencies are used when writing at least two color channels in order to provide otherwise unavailable halftone geometries. Examples will be given for a 600 dpi square pixel device. The method is equally applicable to square and non-square resolutions, or devices using a Pulse Width Modulator (PWM) to approximate high resolutions or multi-level output, however. It is also applicable to systems that can alter the drum or feed mechanism rate and/or ink jet devices with variable droplet size and/or diluted colorants.

In general, according to one aspect, the invention features a method for driving a printing system to generate a color image. In one example, this printing system is an inkjet printer or electrophotographic device such as a laser printer. In other applications, the printing system is an offset printing system that uses an imagesetter to image film, which is then used to make the color plates for the various color separations, or a platesetter that directly images the separate plates.

The method comprises driving the printing system to generate pixels for a first color at a first pixel period, and driving the printing system to generate pixels for a second color at a second pixel period, which is different from the first pixel period.

In the preferred embodiment, the printing system is an inkjet or laser printing device, the different pixel resolutions being used to render images on typically paper substrates.

In the case of an inkjet printer, the different pixel resolutions are used for the different colors by driving the ink jet print heads at different pixel pitches.

In a typical application for this invention, it is applied to relatively low resolution devices such as devices that print at resolutions of about 1200 dots per inch and less. It is particularly helpful with devices that have resolutions of only about 600 dots per inch.

In general, according to another aspect, the invention features a printing system. The system comprises a raster image processor for converting a received image into a rasterized image comprising a separate halftone separations for each of the print colors. According to the invention, these halftone separations have different pixel periods. Then, a print engine is used for printing the color separations at the different periods on a print media.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of a color electrophotographic print system according to the present invention;

FIG. 2 is a schematic diagram of an inkjet printer according to the present invention;

FIG. 3 is a plot showing the change in the pixel pitch or frequency when adjusting the pixel period in the horizontal direction according to the present invention;

FIG. 4 is a schematic view showing the rational cells for cyan and magenta screens and a non-integer black cell period for moiré cancellation; and

FIG. 5 is a flow diagram illustrating the method for driving a rendering device to generate a color image according to the present invention.

### DETAILED DESCRIPTION OF THE PREFERRED EMBODIMENTS

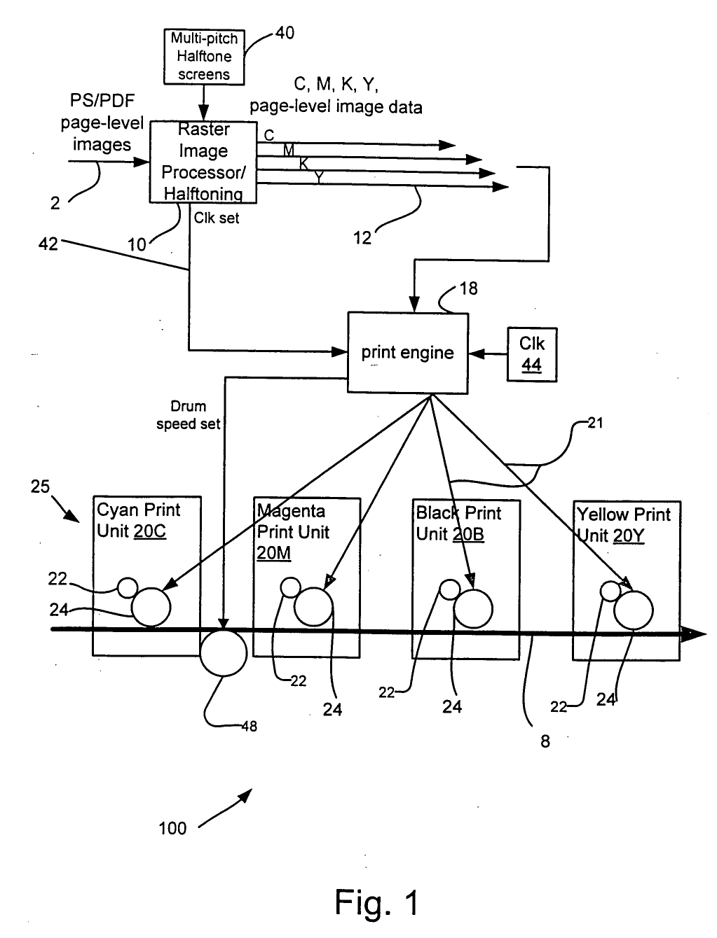

FIG. 1 shows a printing system 100 that has been constructed according to the principles of the present invention.

In the common implementation, the input source file 2 is a Postscript (or any other PDL) file, or portable document file (.pdf). This typically comprises contone images of the pages to be printed on a paper web 8. In other cases, the image is represented using GDI (graphical device interface) calls. GDI is a standard for representing graphical objects for transmission from a computer to an output device, such as a printer.

A raster image processor (RIP) 10 is then used to convert, or rip, the source file(s) or calls into a format appropriate for electrophotographic or offset, for example, printing. That is, the page-level images are halftoned and converted into a format appropriate for raster scanning of the halftone image. Thus, the raster image processor 10 generates four data sets of page-level halftone image data. Each data set represents a different color plane or separation that is used in color printing units 20C, 20M, 20B, and 20Y.

In the offset printing example, the different color data sets are used in the production of plates or rollers.

In a more common electrophotographic example, the data sets are used to expose photosensitive drums 24 to create a latent electrostatic image for transferring toner to the print media 8. In other examples, however, the color spectrum is built on a single photosensitive drum and then transferred to the print media in one or more cycles.

Digital halftoning involves conversion of the contone images and text to a binary, or halftone, representation. Color tone values of the contone image elements become binary dot patterns that, when averaged, appear to the observer as the desired color tone value. The greater the coverage provided by the dot pattern, the darker the color tone value.

A common approach to creating digital halftones uses a threshold mask to simulate the classical optical approach. This mask is an array of thresholds that spatially correspond to the addressable points on the output medium. At each location, an input value from the contone image is compared to a threshold to make the decision whether to print a dot or not. A small mask (tile) can be used on a large image by applying it periodically.

According to the invention, screens 40 are provided for each of the color separations. According to the invention, the pixel pitches of the screens are different from each other. A screen set is designed that has desirable properties for moiré cancellation, for which at least two of the screens have a cell structure that uses two different pixel periods or pitches in the scan direction (x-axis) or the scan and paper feed directions (x and y axes).

Preferably the pixel periods for the screens are both close to the “native” resolution of the device.

Changing the horizontal spatial period of the pixels gives control of only one degree of freedom, but a general parallelogram shaped halftone cell has four degrees of freedom. So, using this method of this one embodiment does not give complete control over the screen parameters. In fact, only one of either the two angles or frequencies can be set exactly. Increasing the pixel period in the x-direction will have the effect of contracting the frequency in the x-direction, and vice-versa.

Thus, the “RIPping” process yields a set of color planes. In the specific example, these are cyan, magenta, black, and yellow page-level raster image data. This is the one bit image data for the half-tone image.

The raster image processor 10, in some embodiments, produces a clock set signal 42. This signal determines the pixel clock frequencies required to render the screens at their different pixel periods. In other examples, the different pixel periods for the color separations are stored in the CMYK page-level image data files.

In other embodiments, the processor 10 also produces drum drive signals dictating the revolution speed of the print drum, dictating the size of the pixels or pixel pitch in the y-axis direction.

These page-level image data are received by a print engine 18, which in the case of a laser printer is the imaging drive system. This device or computer feeds the data that governs the selective exposure of the drums 24 thus controlling the deposition of the colorant on the print media 8.

In example of a laser printer, the drums 24 of the color separation print units 20C, 20M, 20B, 20Y are exposed by light emitting diode bars 21 with the image associated with the corresponding color so that they pick up toner from toner application drum or unit 22 in the desired pattern and transfer the toner to the media 8. Specifically, the cyan drum is imaged with the cyan separation in a cyan print unit 20C of the printer 25, the magenta drum is imaged with the magenta separation in the magenta print unit 20M, the black printing drum is imaged with the black separation in the black print unit 20B, and the yellow drum is imaged with the yellow separation in the yellow print unit 20Y. The media 8 then successively passes through each of these print units 20C, 20M, 20B, and 20Y to receive the corresponding toner.

In the example of a platesetter, the rollers or plates, which were either directly exposed in an imaging engine or produced from the film exposed in an imaging engine, are then used in the web printing press. Specifically, the cyan plate is loaded into a cyan print unit 20C of the press, the magenta plate is loaded into a magenta print unit 20M, the black printing plate is loaded into the black print unit 20B, and the plate for the yellow color plane is loaded into the yellow print unit 20Y. The web then successively passes through each of these print units 20C, 20M, 20B, and 20Y, each printing unit applying its color to thereby create a full spectrum image on the media 8.

According to the invention, the print engine 18 also sets a clock frequency for the pixel clock 44 for the imaging engine 18. This clock determines the speed in which the laser beam is modulated and thus the size or pitch or period of the pixels that are formed on the media 8 in the x-axis direction. Thus, the clock 44 is set so that the screens for the various color separations are printed with a pixel pitch that is consistent with the pixel periods of the page-level image data.

In another embodiment, the engine 18 also produces a drum speed set signal that is used to set the revolution rate of the feed drum or media feed mechanism 48. This controls how fast the drum 48 turns and thus the size or pitch of the pixels in the y-axis direction.

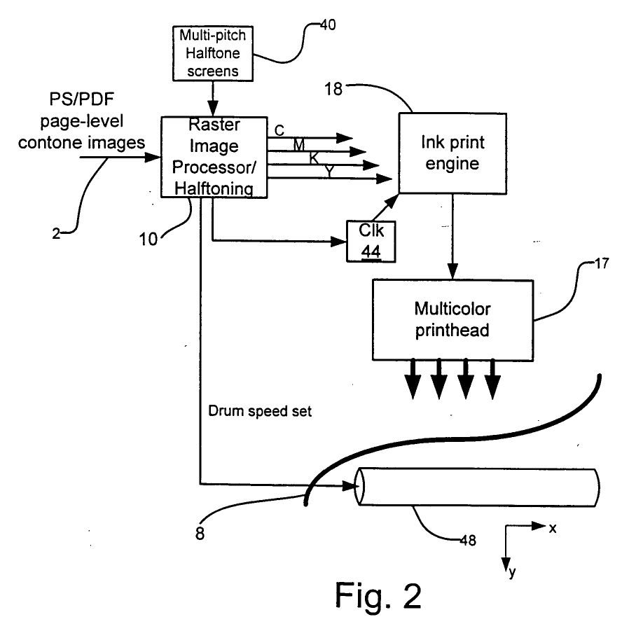

FIG. 2 illustrates an inkjet print system according to the present invention. In this example, the contone image data 2 are again provided to a raster image processor halftoning stage 10. This is also provided with the multi-pitch halftone screens 40.

The resulting CMYK color separations are provided to an inkjet print engine 18. The halftoning stage also controls the inkjet printhead clock 44 and sends a drum speed set signal to drum 48, in some embodiments. Thus, the raster image processor sets the pixel clock rate 44 and the drum speed 48 so that when each of the color separations is printed on the printed matter 8 with the printhead 17, the corresponding pixels are generated with a period and pitch that is consistent with the screens for the corresponding color separations.

In some examples, the engine 18 controls the speed at which the inkjet printhead 17 deposits ink on the paper 8 or the head's lateral scan speed, including possibly the size of the ink drops.

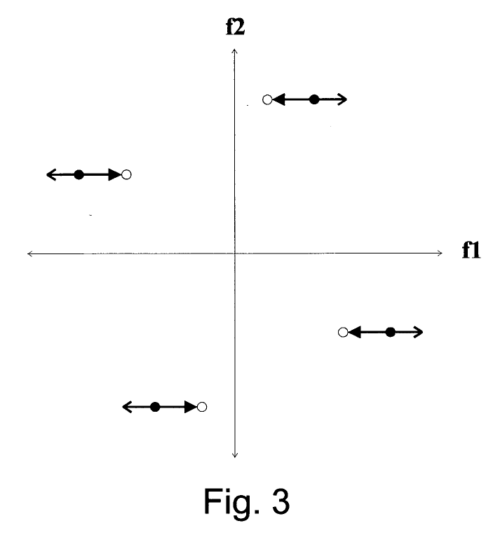

FIG. 3 illustrates the effect of changing the pixel periods. Increasing the pixel period in the x-direction will have the effect of contracting the frequency in the x-direction, and vice-versa. In many situations, this change is all that is necessary.

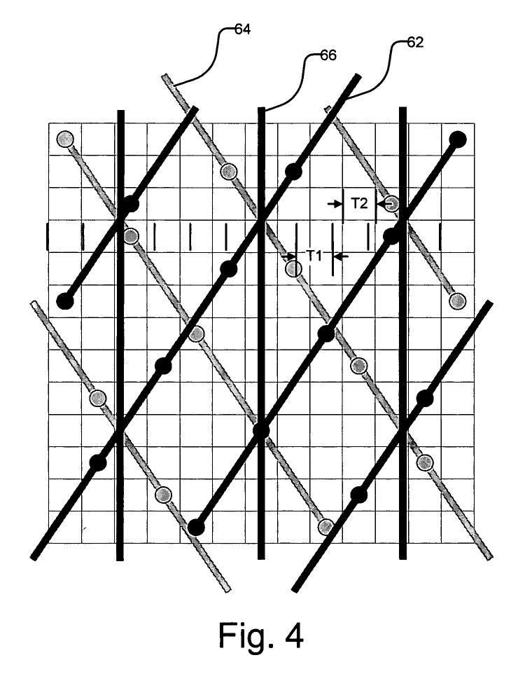

FIG. 4 illustrates the relationship between the screens for each of the color separations.

As an example, we will discuss a line screen set, so that only one angle and frequency need to be considered per screen. If Cyan screen 62 and Magenta 64 are specified to be line screens with slope ⅔ and −⅔ based on a square cell and square pixels of period T2, it can be calculated that the pixel period of the Black screen 66, which is set at zero (0) degrees, should have a pixel period of 13/3 pixels of period T2 in order to cancel the second order moiré.

Since we need an integer number of pixels, let us choose the Black period to be 4 pixels of size T1. It can be easily calculated that T1=13/12 T2. Therefore, if T1 corresponds to, say, 600 dpi , the C,M resolutions T2 should be set to 650 dpi (=13/12*600).

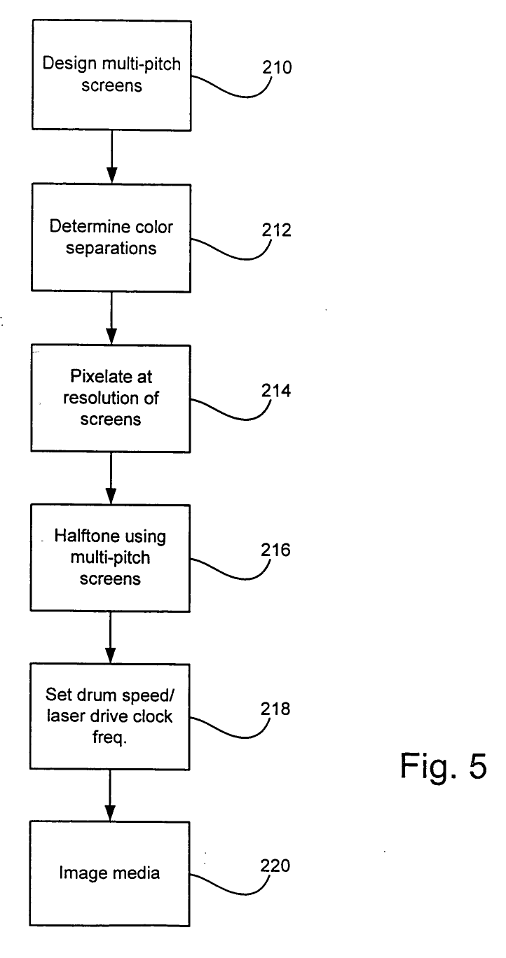

FIG. 5 illustrates the process. The screens with the different pitches for the various color separations are designed in step 210.

Then the color separations are determined in step 212 during the printing process.

The image rasterizer will pixelate the different color channels at the different desired resolutions in step 214. Then the channel images are halftoned using the designed screens to create a colorant image for each of the color channels in step 216. The clock frequency used to generate the signal is adjusted or the drum step set to achieve the different resolutions in step 218. Finally, these images are eventually used to generate signals to drive the laser or printhead in step 220.

While this invention has been particularly shown and described with references to preferred embodiments thereof, it will be understood by those skilled in the art that various changes in form and details may be made therein without departing from the scope of the invention encompassed by the appended claims.

It is claimed:

1. A method for driving a printing system to generate a color image comprising:
driving the printing system to generate pixels for a first color at a first pixel period; and
driving the printing system to generate pixels for a second color at a second pixel period, being different from the first pixel period.

2. The method as claimed in claim 1, wherein the printing system comprises an electrophotographic print device that generates the pixels for the first color on a print media and generates the pixels for the second color on the print media.

3. The method as claimed in claim 1, wherein the printing system comprises an inkjet printer, and:
driving the printing system to generate the pixels for the first color comprises driving a first color print head at the first pixel period; and
driving the printing system to generate the pixels for the second color comprises driving a second color print head at the second pixel period.

4. The method as claimed in claim 1, wherein the printing system comprises a platesetter or imagesetter that generates the pixels for the first color on a first plate and generates the pixels for the second color on a second plate, the first plate and the second plate being loaded into an offset printer for printing the color image.

5. The method as claimed in claim 1, wherein driving the printing system to generate pixels at the first pixel period and the second pixel period comprises driving a print head at different pixel clock frequencies.

6. The method as claimed in claim 1, wherein driving the printing system to generate pixels at the first pixel period and the second pixel period comprises driving a feed drum at different speeds.

7. The method as claimed in claim 1, wherein the printing system is a low resolution device having a native resolution of less than 1200 dots per inch.

8. The method as claimed in claim 1, wherein the printing system is a low resolution device having a native resolution of about 600 dots per inch.

9. The method as claimed in claim 1, further comprising selecting the first pixel period relative to the second pixel period to minimize moiré patterns in the color image.

10. A printing system comprising:
a raster image processor for converting a received image into a rasterized image comprising separate halftone color separations for each print colors having different pixel periods; and
a print engine for printing the color separations at the different pixel periods on a print media.

11. The system as claimed in claim 10, wherein the print engine comprises an electrophotographic print device that generates pixels for a first color on a print media and generates pixels for a second color on the print media.

12. The system as claimed in claim 10, wherein the print engine comprises an inkjet printer that generates pixels for a first color by driving a first color print head at a first pixel period and generates pixels for a second color by driving a second color print head at a second pixel period.

13. The system as claimed in claim 10, wherein the print engine comprises a platesetter or imagesetter that generates pixels for a first color on a first plate and generates pixels for a second color on a second plate, the first plate and the second plate being loaded into an offset printer for printing a color image.

14. The system as claimed in claim 10, wherein the print engine has a print head that is driven at different pixel clock frequencies.

15. The system as claimed in claim 10, further comprising a print drum that is driven at different speeds.

16. The system as claimed in claim 10, wherein the print engine is a low resolution device having a native resolution of less than 1200 dots per inch.

17. The system as claimed in claim 10, wherein the print engine is a low resolution device having a native resolution of about 600 dots per inch.

18. The system as claimed in claim 10, wherein a first pixel period relative to a second pixel period is selected to minimize moiré patterns in a printed image.

19. A screen set for converting a color contone image to a color halftone image comprising different screens for different colors having different pixel periods.

20. The screen set as claimed in claim 19, wherein the pixel periods for the different screens are selected relative to each other to minimize moiré patterns in the halftone image.
